(19) United States
(12) Patent Application Publication
(10) Pub. No.: US 2018/0271087 A1
(43) Pub. Date: Sep. 27, 2018

(54) DEVICE FOR VASCULARIZED COMPOSITE ALLOTRANSPLANT PRESERVATION AND USE THEREOF

(71) Applicants: UNIVERSITY OF PITTSBURGH - OF THE COMMONWEALTH SYSTEM OF HIGHER EDUCATION, Pittsburgh, PA (US); ORGAN ASSIST B.V., Groningen (NL)

(72) Inventors: Paulo Artur Chaves Fontes, Pittsburgh, PA (US); Arjan van der Plaats, Meeden (NL)

(73) Assignees: UNIVERSITY OF PITTSBURGH - OF THE COMMONWEALTH SYSTEM OF HIGHER EDUCATION, Pittsburgh, PA (US); ORGAN ASSIST B.V., Groningen (NL)

(21) Appl. No.: 15/758,616

(22) PCT Filed: Sep. 9, 2016
(86) PCT No.: PCT/US2016/051122

§ 371 Date: Mar. 8, 2018

Related U.S. Application Data
(60) Provisional application No. 62/217,565, filed on Sep. 11, 2015.
(60) Provisional application No. 62/375,549, filed on Aug. 16, 2016.

(51) Int. Cl. A01N 1/02

(52) U.S. Cl. CPC A01N 1/0247; A01N 1/0226

(57) ABSTRACT

Disclosed herein is a device for machine perfusion of an organ that includes a chamber including an organ support platform for supporting an organ and a perfusion circuit for providing an oxygenated perfusion fluid to the organ and carrying oxygen-depleted perfusion fluid away from the organ. The organ support platform includes perforations for fluid drainage. In some examples, the organ support platform is substantially horizontal. The device also includes a pump for circulating the perfusion fluid through the perfusion circuit, an oxygenating device in the perfusion circuit to oxygenate the perfusion fluid, and a temperature regulator for controlling the temperature of the perfusion fluid in the perfusion circuit. The device in some examples also includes a vascular perfusion cannula through which the perfusion fluid can flow to an organ placed on the organ support platform. Also disclosed are methods of perfusing an organ utilizing the machine perfusion devices.

### CROSS REFERENCE TO RELATED APPLICATIONS

This application claims the benefit of U.S. Provisional Application No. 62/217,565, filed Sep. 11, 2015, and U.S. Provisional Application No. 62/375,549, filed on Aug. 16, 2016, both of which are incorporated by reference in their entirety.

### ACKNOWLEDGMENT OF GOVERNMENT SUPPORT

This invention was made with government support under grant number W81 XWH-13-2-0061 awarded by the U.S. Army Medical Research and Materiel Command. The government has certain rights in the invention.

### FIELD

This disclosure relates to devices and methods for preserving or recovering tissues or organs during machine perfusion, particularly for composite tissues.

### BACKGROUND

Since 1998, over 95 upper extremities and 26 craniomaxillofacial vascularized composite allotransplants have been performed around the world (Petruzzo et al., Transplantation 90:1590e3, 2010). However, growth has been slow, largely due to current techniques for graft preservation and the subsequent immunological barriers faced after transplantation, where non-life saving procedures can lead to a lifetime burden of complications related to immunosuppressive therapy (Diaz-Siso et al. Clin. Transpl. 27:330e7, 2013). Recent studies indicate that more than 28,000 potential organ donors die each year in the United States (Wall et al., JAMA 313:2321-2322, 2015). However, a major obstacle to organ and tissue transplantation today remains the limited supply of suitable donors.

Since June 2013, vascularized composite allotransplant (VCA; also referred to as composite tissue allotransplant (CTA)) programs in the United States have come under United Network for Organ Sharing definition, which has major implications in all regulatory aspects of transplantation and organ allocation (Cendales et al., Transplantation 93:1086e7, 2012). In VCA, unlike internal organs, matching of skin color, tone, gender, and size of the graft, in addition to blood type, between donor and recipient imposes limitations on further increasing in the number of transplants (Chung et al., Plast. Reconstr. Surg. 125:589e98, 2010). The need to share organs and tissues across a wider geographic distance imposed by the national donor allocation system managed by the Organ Procurement and Transplantation Network, can have also a further negative impact due to the cold ischemia time (CIT) prior to graft implantation in VCA (Jensen et al., J. Hand Surg. Am. 37:2126e35, 2012). The implementation of federal policies for VCA allocation should improve recipient matching while forcing sharing across wider geographic distances. However, the potentially greater distance might risk an unacceptable CIT for several donor-recipient combinations.

### SUMMARY

Disclosed herein is a device for machine perfusion of an organ (such as a vascularized composite allotransplant (VCA, also referred to herein as a composite tissue graft (CTA)) and methods for preservation and/or recovery of an organ utilizing the device disclosed herein, for example, in combination with an oxygen carrier solution, such as a hemoglobin-based oxygen carrier (HBOC) solution.

Disclosed herein is a device for machine perfusion of an organ that includes a chamber including an organ support platform for supporting an organ (such as a VCA) and a perfusion circuit for providing an oxygenated perfusion fluid to the organ and carrying oxygen-depleted perfusion fluid away from the organ. In some embodiments, the perfusion circuit includes fluidly connected components including at least one fluid inlet to the chamber and at least one fluid outlet from the chamber. The organ support platform includes one or more perforations for fluid drainage and is placed in the chamber such that it does not rest on the bottom surface of the chamber. In some examples, the organ support platform is substantially horizontal. The device also includes a pump for circulating the perfusion fluid through the perfusion circuit, an oxygenating device in the perfusion circuit to oxygenate the perfusion fluid, and a temperature regulator for controlling the temperature of the perfusion fluid in the perfusion circuit. The device in some examples also includes a vascular perfusion cannula through which the perfusion fluid can flow to an organ placed on the organ support platform.

Also disclosed herein is a device assembly that includes a device disclosed herein, an organ (such as a VCA) placed on the organ support platform in the chamber, and a cannula connected to the perfusion circuit and inserted in an artery of the organ.

Disclosed herein are methods of machine perfusion of an organ (such as a VCA), comprising perfusing the organ with an oxygen-carrier solution (such as an HBOC solution). In some embodiments, the external portion or surface of the organ (such as skin on a VCA) is not submerged in the perfusion fluid during perfusion. In some examples, the organ is placed in a substantially horizontal position during perfusion. In some examples, the organ is perfused through one or more arteries (for example, using a pulsatile flow) and the perfusion solution passively drains from the organ. In particular examples, the methods include placing a VCA on a platform in the chamber of a device described herein, inserting a cannula in an artery of the VCA, wherein the cannula is attached directly or indirectly to the perfusion circuit of the device, and perfusing the VCA with an oxygenated perfusion solution (for example, an oxygenated HBOC solution).

The foregoing and other features of the disclosure will become more apparent from the following detailed description, which proceeds with reference to the accompanying figures.

### BRIEF DESCRIPTION OF THE DRAWINGS

FIG. 1 is a schematic diagram of an exemplary VCA machine perfusion device. A platform with perforations 1 is placed horizontally in a perfusion chamber and a graft (such as a VCA) 2 is placed horizontally and in an anatomic position within the perfusion chamber. The arrows 3, show free gravity drainage from the graft 2 through the platform 1 and pulsatile flow is introduced through an infusion port (e.g., cannula) 4. Arrows show the direction of fluid flow when the device is in use. Flow into the perfusion chamber is oxygenated perfusion fluid (e.g., through the arterial port) and flow out of the perfusion of the graft).

FIG. 2 is a schematic diagram of an exemplary VCA machine perfusion chamber, showing a limb placed in the chamber and having the infusion port aligned with the limb vasculature. The limb is fully supported by a horizontal platform including holes that allow free lymphatic and venous drainage.

FIGS. 3A and 3B are panels showing anatomical features of a vertical rectus myocutaneous (VRAM) graft. FIG. 3A is a schematic diagram of the anatomical features of the VRAM graft in a human SEA, superior epigastric artery; SEV, superior epigastric vein; IMA, internal mammary artery; IMV, internal mammary vein. FIG. 3B is a digital image of a VRAM graft (measuring about 15×5 cm) in a swine model.

FIGS. 4A and 4B are digital images of an exemplary polyvinyl chloride (PVC) mesh platform for machine perfusion of VCAs (FIG. 4A) and a VRAM graft being perfused through a pulsatile arterial port while resting on the PVC mesh platform (FIG. 4B).

FIG. 5 is a graph showing perfusion flow rates (ml/min; mean±SD) of VRAM from four animals over 14 hours of machine perfusion with HBOC solution.

FIG. 6 is a graph showing perfusion pressures (mm Hg; mean±SD) of VRAM from four animals over 14 hours of machine perfusion with HBOC solution.

FIG. 7 is a graph showing oxygen delivery (ml O₂/min/g tissue; mean±SD) to VRAM from four animals over 14 hours of machine perfusion with HBOC solution.

FIG. 8 is a graph showing perfusate lactate levels (mmol/L; mean±SD) from VRAM from four animals over 14 hours of machine perfusion with HBOC solution.

FIG. 9 is a graph showing perfusate pH values (mean±SD) from VRAM from four animals over 14 hours of machine perfusion with HBOC solution. No NaHCO₃⁻ infusions were necessary to sustain a physiologic pH.

FIG. 10 is a graph showing Myoglobin serum levels (ng/ml) in the recipient's peripheral blood over a seven day period. The study group (MP; 1) is compared to the control (CSP; 2) group. The CSP group had significantly (p<0.05) higher levels of myoglobin in the serum after transplantation, which represents a major degree of muscle necrosis in the CSP when compared to the MP group.

FIGS. 11A and 11B are digital images of a VRAM graft seven days after transplantation of a control (CSP) graft (FIG. 11A) or a machine perfused (MP) graft (FIG. 11B). The MP graft has normal features, while the CSP graft has clear signs of ischemic skin ulcerations and necrosis, with a significant necrotic damage within the nipple.

FIG. 12 is a pair of digital images from H&E stained punch biopsies (40× magnification) from machine perfused (left) or CSP (right) grafts on the second post-operative day (POD). There is a significant amount of apoptosis and necrosis in the muscle tissue within CSP graft. The muscle tissue from the MP graft has normal features.

FIG. 13 is a pair of digital images from H&E stained punch biopsies (40× magnification) from machine perfused (left) or CSP (right) grafts on the fourth post-operative day. There were mild signs of inflammation in the muscle tissue of the MP graft. There were major signs of necrosis and inflammation in the muscle tissue of the CSP graft, which characterize a moderate to severe ischemia-reperfusion injury. These histological features were not observed in the MP group.

FIG. 14 is a pair of digital images of punch biopsies from H&E stained punch biopsies (40× magnification) from machine perfused (left) or CSP (right) grafts on the seventh post-operative day. There are mild signs of inflammation and features of early regeneration within the muscle tissue of the MP graft. There are signs of massive necrosis in the CSP graft with a dense inflammatory infiltrate composed mainly of lymphocytes, neutrophils, and macrophages. There are signs of irreversible damage within the CSP graft muscle tissue and no signs of regeneration.

FIG. 15 is a series of digital images from H&E (20× magnitude) stained skin biopsies obtained from the VRAM grafts during machine perfusion or CSP at baseline, 7 hours, or 14 hours. The top panels are from the study (MP) group and the bottom panels are from the control (CSP) group. There are no signs of any structural damage within both groups. These images show that the MP system is able to maintain tissue integrity over a 14 hour period of perfusion under low pressures and with the HBOC at 21° C.

FIG. 16 is a series of digital images showing H&E staining of VRAM punch biopsies obtained during ex vivo preservation at baseline, 7 hours, and 14 hours (top, machine-perfused; bottom CSP). The arrows indicate the development of early contraction bands (CB) in the CSP group.

FIG. 17 is a pair of digital images of H&E staining of full thickness biopsy from MP/HBOC (left) or CSP (right) 48 hours after VRAM graft implantation. The arrow points to a CB, which showed signs of progression in the CSP group.

FIG. 18 is a pair of digital images of tissues following transplantation (MP/HBOC, left; CSP, right) on day 0 post-operative.

FIG. 19 is a series of panels showing the surgical wound (top) and tissues (bottom) obtained through punch biopsies from both groups (MP/HBOC, left; CSP, right) at the second post-operative day. The degree of apoptosis and necrosis was significantly higher in the CSP group than the MP group, where intraseptal lymphocyte infiltration and progressive muscle fiber atrophy was also seen. Cell debris (both from the resident cell populations and from infiltrating leukocytes), proteinaceous fluid containing fibrin, fewer macrophages and occasional lymphocytes and/or plasma cells were seen in the CSP. None of these changes were seen in the MP/HBOC group.

FIG. 20 is a pair of digital images of H&E stained punch biopsies from both groups (MP, left; CSP, right) at the fourth post-operative day. The degree of necrosis was significantly higher in the CSP group. The CSP showed a higher degree of inflammation. There were clear signs of myofiber necrosis, myopathic changes in addition to edema and/or hemorrhage in the CSP group. Progressive lymphocyte infiltration and areas of hemorrhage was seen. The loss of muscle fibers and hypereosinophilic degenerative fibers were also seen in the CSP. Progressive granulomatous inflammation was seen among a number of aggregated, large, activated macrophages, epithelioid macrophages, or multinucleated giant cells. The MP/HBOC group had muscle tissue with normal histological features.

FIG. 21 is a series of digital images showing the surgical wound and the tissues obtained through punch biopsies from both groups (MP, left; CSP, right) at the seventh post-operative day. There were clear signs of superficial necrosis (nipple area—red circle) with extensive ulceration in the CSP graft (top right). The MP/HBOC graft had normal features (top left). The lower panels show the VRAM grafts after the termination of the study (euthanasia on the 7^{th} POD) in an inverted position. There were clear signs of extensive tissue necrosis within the subcutaneous in the CSP group (bottom right).

FIG. 22 is a diagram showing an integrated system analysis utilizing dynamic Bayesian networks (DBN) inference. There was a central role for TNF-α in the CSP group as major promoter for sustained and enhanced inflammation (left panel).

FIGS. 23A and 23B are panels showing a dynamic network analysis (DyNA) of complexity in the inflammatory network. FIG. 23A shows network analysis during ex vivo perfusion in the control (CSP; top) and MP/HBOC (bottom) groups. The CSP group showed a lower degree of complexity, despite sustaining a similar amount of connections (FIG. 23B).

FIG. 24 is a series of graphs showing changes in metabolite levels over time in MP/HBOC VRAMs or CSP VRAMs.

### DETAILED DESCRIPTION

Cold static preservation (CSP) has been the standard of care for organ and tissue preservation for almost 40 years (Belzer et al., Transplantation 45:673-676, 1988). CSP relies on induced hypothermia (4° C.), where the preservation solution is primarily designed to act as a potent buffer while keeping the homeostasis between the intra- and extracellular spaces under anoxic and static (no flow) conditions for a limited amount of time. Cell membrane integrity as an active energy-requiring process deteriorates under these unusual (anoxia and hypothermia) circumstances, while tissue integrity experiences a progressive and sometimes irreversible decay (Rauen et al., J. Invest. Med. 52:299-309, 2004). CSP was initially intended to bridge this mandatory cold ischemia time (CIT), which can lead to a prolonged period without proper oxygenation. Cold ischemic injury can induce irreversible perturbations in osmoregulation, energetics, and aerobic metabolism. In VCAs, CSP induces a progressive reduction in interstitial oncotic pressure, allows interstitial expansion and edema, and leads to further capillary compression and tissue injury (Blaisdell, Cardiovasc. Surg. 10:620, 2002).

During cold ischemia, lactic acid generated from the anaerobic metabolism of glucose contributes to intracellular acidosis, resulting in lysosomal instability and altered mitochondrial function. In addition, apart from the effects of hypothermia and ischemia following organ retrieval and during transport, there is also the effect of ischemia-reperfusion injury (IRI) after graft implantation (Carden et al., J. Pathol. 190:255-266, 2000). IRI has only recently received attention in VCAs, where injury patterns in skeletal and cardiac muscle demonstrated parallels (Castillero et al., Biochem. Biophys. Res. Commun. 457:106-111, 2015). As VCAs are composed of different tissues, the consequences of IRI may differ in a tissue-specific manner. Muscle and adipose tissue have an enhanced metabolism and are therefore more susceptible to damage from IRI (Whitaker et al., Plast. Reconstr. Aesthetic Surg. 121:152e, 2008). Furthermore, viable skin could still be found in musculocutaneous autografts, although muscular tissue had already demonstrated necrotic changes immediately following transplantation (Lanzetta et al., Transplant Proc. 36:664-668, 2004).

Most procedures performed with the intention to perfuse VCA within an extracorporeal environment have been performed with the use of commercially available pumps primarily developed for research applications. For example, Dragu et al. (Arch. Orthop. Trauma Surg. 131:849-855, 2011) have developed a machine perfusion method to preserve VCAs by using a volumetric infusing pulsatile rollover pump (Braun Infusomat® Space, Melsungen, Germany) and Jonosteril (Fresenius Jonosteril®, Fresenius, Bad Homburg, Germany). Muller et al. (J. Surg. Res. 181:170-182, 2013) recently developed a similar extracorporeal perfusion system for swine limbs by using a commercially available rotatory blood pump (Medos DeltaStream Blood Pump, Model DP2, Medos Medizintechnik AG, Stolberg, Germany) in combination with a non-oxygen carrier solution (Voluven®, Fresenius, Bad Homburg, Germany). The same pump was utilized by a different group in combination with oxygenators (Medos Hilite 800 LT, Medos Medizintechnik AG, Stolberg, Germany) and a cooling device (Heater-Cooler Unit HCU30, Maquet GmbH and Co. KG, Rastatt, Germany) while using blood at 32° C. as the perfusate for the extracorporeal perfusion system (Constantinescu et al., J. Surg. Res. 171:291-299, 2011). However, there are no current medical devices exclusively developed for VCA preservation prior to transplantation or for limb recovery or repair (e.g., prior to reimplantation or reattachment).

Disclosed herein is a new system for VCA preservation and/or recovery that combines a machine perfusion device with an oxygen carrier solution, such as an HBOC solution. In particular, the device utilizes pulsatile arterial flow at low pressures with free drainage of the perfusate and in some examples, maintains the VCA in a relatively horizontal position. As shown in the Examples (below), this system has been successfully utilized in pre-clinical large animal experiments and showed great superiority to the cold storage preservation (CSP), the current standard of care for transplantation.

### I. Abbreviations

CB contraction band
CIT cold ischemia time
CSP cold storage (or static) preservation
CTA composite tissue allotransplant
HBOC hemoglobin-based oxygen carrier
IRI ischemia-reperfusion injury
MP machine perfusion
POD post-operative day
PVC polyvinyl chloride
VCA vascularized composite allotransplant
VRAM vertical rectus myocutaneous

### II. Terms

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references mentioned herein are incorporated by reference in their entirety. In case of conflict, the present specification, including explanations of terms, will control. In addition, the materials, methods, and examples are illustrative only and not intended to be limiting.

In order to facilitate review of the various embodiments of this disclosure, the following explanations of specific terms are provided:

Hemoglobin-based oxygen carrier (HBOC): Molecules or compositions with oxygen carrying capabilities derived from the presence of hemoglobin. In some examples, HBOCs include isolated or purified hemoglobin (sometimes referred to as “acellular” HBOCs). Exemplary acellular HBOCs contain polymerized hemoglobin (for example, bovine or human hemoglobin), for example HBOC-201 (HEMOPURE, OPK Biotech, Cambridge, Mass.), HEMOLINK (Hemosol, Inc., Toronto, Canada), and POLYHEME (Northfield Laboratories, Evanston, Ill.) or encapsulated hemoglobin (such as liposome- or polymersome-encapsulated hemoglobin). In other examples, HBOCs include red blood cells. An exemplary HBOC is disclosed in International Patent Publication No. WO 2014/059316, incorporated by reference herein in its entirety.

Organ: A part of the body, tissue, or portion thereof that can be transplanted or preserved ex vivo. Organs include, but are not limited to liver, kidney, heart, lung, pancreas, small intestine, and limb (such as arm or leg, or portion thereof), or extremity (such as hand, foot, finger, toe, or a portion thereof). As used herein, “organ” also includes other tissues, such as tissue grafts or composites (also referred to as vascularized composite allotransplants, composite tissue grafts or composite tissue allotransplants herein).

Perfusion: Circulation of a fluid (also referred to as a perfusion solution or perfusate) through an organ or VCA to supply the needs of the organ or VCA to retain its viability (for example, in an ex vivo system). In some examples, the perfusion solution includes an oxygen carrier (for example, a hemoglobin-based oxygen carrier).

“Machine perfusion” refers to introduction and/or removal of a perfusion solution to an organ by a mechanical device. Such devices may include one or more chambers for holding an organ and a perfusion solution, one or more pumps for delivery of the perfusion solution to the organ, one or more means to regulate temperature of the perfusion solution, and one or more means to oxygenate the perfusion solution. In some examples, machine perfusion includes introduction of an oxygen carrying fluid into an organ and removal of oxygen depleted fluid from the organ by circulation of the oxygen carrying fluid through the organ.

In some embodiments, the perfusion can be pulsatile, with periodic increases and decreases of flow, to mimic arterial blood flow from a beating heart. In other embodiments, the perfusion can be continuous, with a substantial absence of flow rate variations, to mimic venous blood flow under most physiologic conditions.

Vascularized Composite Allotransplant (VCA): Also referred to as a composite tissue graft or allotransplant (CTA). A construct that includes multiple types of tissue, such as skin, muscle, tendon, cartilage, fat, bone, nerve, blood vessels, and/or other tissue types. In some examples, a VCA is a composite tissue allotransplant or portion thereof that is transplanted from (or may be transplanted from) one individual (a donor) to another individual (a recipient). In some examples, a VCA is a limb or extremity (such as an arm, leg, hand, foot, finger, or toe), face (or portion thereof, such as lips, nose, and/or eyelids), larynx, or other body parts. In another example, a VCA includes a model construct, such as a myo-adipo-cutaneous flap (for example, a swine vertical rectus myocutaneous (VRAM) flap). In some examples, as used herein, VCA may also refer to an autologous construct including multiple types of tissue, for example a limb or extremity, or other body part that is reattached to the same individual from which it came.

### III. Machine Perfusion Device

Disclosed herein are devices for machine perfusion of an organ or tissue (e.g., a VCA). In some embodiments, the device includes a chamber that can accommodate an organ and containing an organ support platform on which the organ rests during perfusion. The organ support platform includes one or more perforations (such as a plurality of holes or openings). The device also includes a perfusion circuit for providing an oxygenated perfusion fluid to the organ and carrying oxygen-depleted perfusion fluid away from the organ. The organ support platform is placed in the chamber such that it does not rest on the bottom surface of the chamber. In some examples, the organ support platform is substantially horizontal. The device also includes a pump for circulating the perfusion fluid through the perfusion circuit, an oxygenating device in the perfusion circuit to oxygenate the perfusion fluid, and a temperature regulator for controlling the temperature of the perfusion fluid in the perfusion circuit. The device in some examples also includes a vascular perfusion cannula through which the perfusion fluid can flow to an organ placed on the organ support platform. In some embodiments, the device also includes at least one pressure transducer. In some examples, one or more portions of the device is a disposable unit for single use, such as one or more pump heads, one or more oxygenators, one or more pressure transducers, one or more fluid lines (e.g., tubing, such as the perfusion circuit), one or more cannulas, and/or a chamber including a platform for holding the VCA.

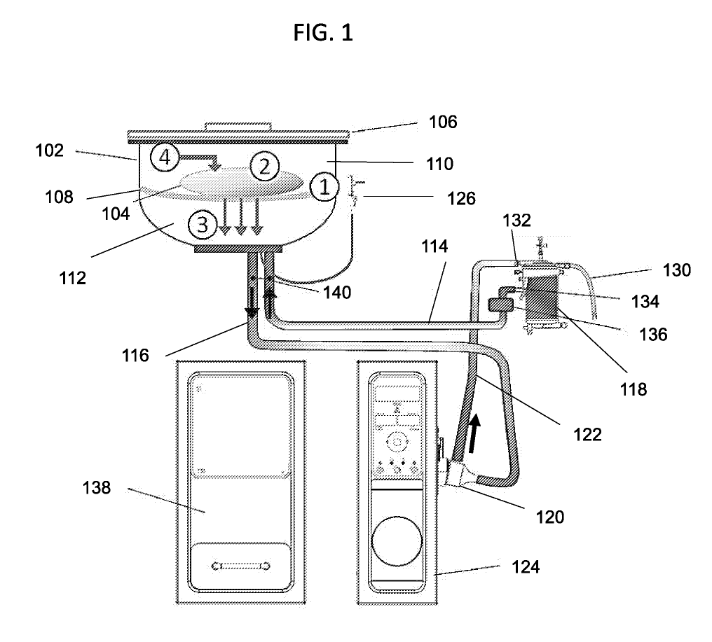

Referring now to FIG. 1, in one exemplary embodiment, the device 100 includes a chamber 102 (such as a chamber with sides and a bottom) that is open at the top and that can accommodate an organ or VCA 104. In some examples, the chamber 102 is large enough to accommodate a limb (such as an arm or leg, or portion thereof), an extremity (such as a hand or foot or portion thereof), or one or more digits (such as one or more fingers or toes, or portions thereof). In other examples, the chamber 102 is large enough to accommodate a craniofacial VCA (such as a face or portion thereof, skull or portion thereof, scalp or portion thereof, or any combination thereof). The cross-sectional shape of the chamber can be any suitable shape, including square, rectangular, ovoid, or hemispherical. One of ordinary skill in the art can select appropriate chamber shape and dimension to contain an organ or VCA within the chamber.

In some embodiments, the chamber also includes a removable lid 106 that fits on the chamber and provides a closed container, for example to provide a clean (or in some examples, sterile) and optionally sealed container for an organ or VCA. When in place the lid 106 also provides for maintenance of external moisture for the VCA (for example, reducing or preventing drying of the external surface or skin of the VCA). In some examples, the lid includes a drape (such as a sterile drape) that is placed on top of the lid (not shown) while covering the perfusion chamber (which may be sealed and sterile). The chamber 102 and/or lid 106 can be made of any material, including plastic, glass, or metal. In one example, the lid 106 is transparent, to allow monitoring and inspection of the contents of the chamber when the lid is in place. In some examples, the chamber 102 and/or lid 106 are made of material that can be sterilized (for example, a material that can be autoclaved) such as plastic that can be sterilized, for example, polyethylene, polypropylene, polycarbonate, or acrylic plastic (e.g., Plexiglass).

The disclosed devices include a support platform 108 within the chamber that is not in contact with the bottom surface of the chamber, creating an upper part 110 and a lower part 112 of the chamber. In some examples, the lower chamber forms a reservoir along the perfusion circuit for containing a portion of the perfusion fluid from the perfusion circuit, wherein the reservoir communicates with an outlet to the second conduit. In some examples, the support platform is held in place by horizontal members (such as pins or bars) inserted in the sides of the chamber (not shown). Other exemplary methods of holding the support platform in the chamber include an inner ridge around the interior of the chamber at a selected distance below the open top of the chamber or by hooks that attach to the platform and hang over the top of the sides of the chamber. One of ordinary skill in the art can identify other arrangements to hold the platform in the chamber such that it is not in contact with the bottom surface of the chamber. As shown in FIG. 1, the organ or VCA 104 rests on the platform 108 in the chamber 102. In some embodiments, the platform 102 is placed so that the organ 104 is not submerged in any fluid that may be present in the lower part of the chamber 112 when it is placed on the support platform 108. In some examples, the external portion or surface of the organ (such as skin on a VCA) is not submerged in the perfusion fluid during perfusion.

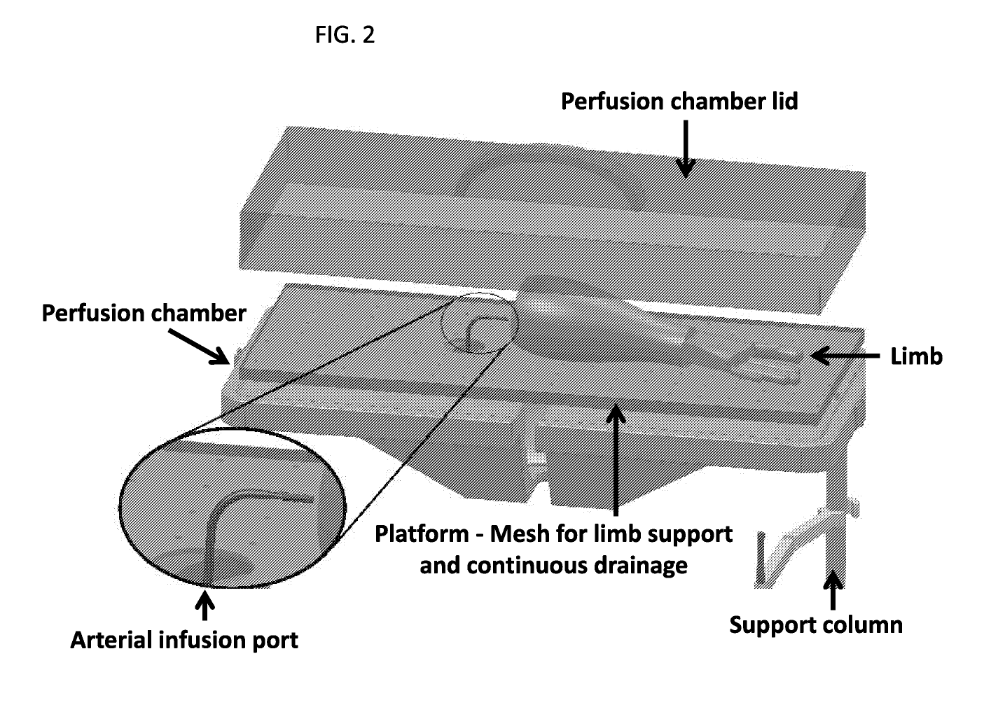

In some embodiments, the platform 108 is substantially flat (for example, as illustrated in FIG. 2). In some examples, the platform is made of a rigid material. In other examples, the platform is a flexible material, such as a flexible mesh. In other embodiments, the platform may be curved or another shape that accommodates the VCA, but still keeps the skin of the VCA substantially dry (for example, not in external contact with the perfusion solution).

In particular examples, the organ support platform is substantially horizontal. In other examples, the platform is placed at a slight angle from horizontal, such as about 15° or less (for example, about 15° or less, 14° or less, 13° or less, 12° or less, 11° or less, 10° or less, 9° or less, 8° or less, 7° or less, 6° or less, 5° or less, 4° or less, 3° or less, 2° or less, or 1° or less), such as about 1-10°, about 5-10°, about 8-15°, about 1-7°, or about 2-5°.

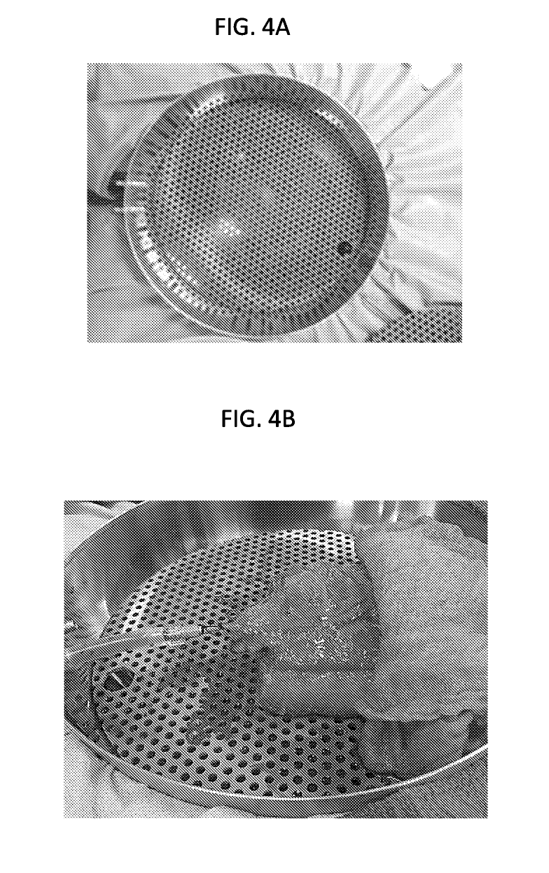

The organ support platform includes one or more holes or perforations that allow for passive fluid drainage from the upper part of the chamber to the lower part of the chamber. An exemplary perforated organ support platform is shown in FIGS. 4A and 4B. In some examples, the platform is made out of mesh material, such as a medical grade mesh (such as polyvinyl chloride (PVC) or polypropylene). The material is one that can be sterilized (for example, autoclaved). In one example, the platform is made of a PVC mesh, such as a plasticized PVC medical mesh. In a particular example, the platform is made of high strength PVC with staggered holes (for example, catalog number 92985T57, McMaster-Carr, Los Angeles, Calif.). One of ordinary skill in the art can identify additional suitable materials for the platform.

The organ support platform can be constructed of any material that can support the weight of an organ or VCA, can be sterilized, and has holes or perforations that allow for sufficient fluid drainage when the device is in use (for example, such that the organ or VCA is not resting in fluid during perfusion). The volume of fluid drained through the platform is substantially equal to the volume of fluid being perfused into the organ or VCA, which varies with the type and size of the transplant. One of ordinary skill in the art can select a platform with a number and size of openings that will provide suitable drainage for a particular organ or VCA. In some examples, the platform has about 20-50% (such as 25-35%, 30-40%, 35-45%, or 32-38%) open space provided by the holes. In some examples, the platform is removable from the chamber, while in other examples, the platform is permanently affixed in the chamber. An exemplary platform placed in a chamber is shown in FIGS. 4A and 4B.

Referring again to FIG. 1, the device 100 also includes a perfusion circuit 140 including a first conduit 114 fluidly connected to the chamber 102 for providing oxygenated perfusion fluid to the organ or VCA and a second conduit 116 fluidly connected to the chamber 102 for carrying oxygen-depleted perfusion fluid away from the organ or VCA. In some embodiments, the first conduit 114 enters the chamber 102 through the bottom surface of the chamber and passes vertically through an opening in the platform 108 (not shown) to the upper part of the chamber 110. One of ordinary skill in the art will understand that the first conduit 114 can also enter through a side or the top of the chamber 102, if desired. Likewise, in some embodiments, the second conduit 116 passes through or is connected to the bottom of the chamber 102 (for example, to facilitate gravity drainage), but one of ordinary skill in the art will understand that it can be placed in other locations in the chamber (such as in a side of the chamber), so long as it is in the lower portion of the chamber 112 and can receive fluid draining from the upper portion of the chamber 110. In some examples, the first conduit 114 includes one or more cannulas (such as a vascular perfusion cannula) (e.g., shown in FIG. 2). The cannula(s) are of a suitable size to be placed in a vessel in the organ or VCA, such as an artery or vein.

In some examples, the first conduit 114 is attached to an oxygenator 118 that is in turn connected to a pump 120 (discussed below). In some examples, the second conduit 116 is also attached to the pump 120. Thus, in some examples, the perfusion circuit circulates the perfusion fluid from the oxygenator 118 through the first conduit 114 to a vascular perfusion cannula (not shown), which is inserted in a vessel of the organ or VCA 104 placed on the platform 108 in the chamber 102. The perfusion fluid drains from the organ or VCA through the perforations in the platform (not shown) into the lower part of the chamber 112, is collected into the second conduit 116, and returns to the pump 120. The perfusion circuit may also include a third conduit 122 that fluidly connects the pump 120 to the oxygenator 118.

In some embodiments, the disclosed devices include a pump 120 that is used to supply perfusion fluid to the organ or VCA 104 in the chamber 102 via the first conduit 114, through the vascular perfusion cannula (not shown). As discussed below, in some examples, the perfusion fluid is introduced into the organ or VCA via an artery with a pulsatile flow. In some examples, the pump is a centrifugal pump or a membrane pump, such as a pump that can produce a pulsatile flow. In some examples, the pump 120 is attached to or included in a pump unit 124, which includes electrical system and software (such as an electronic module) that operates the perfusion system through the controls displayed on the pump unit.

Further referring to FIG. 1, in some embodiments, the disclosed devices also include a pressure transducer 126. In some examples, the pressure transducer 126 is connected to the perfusion circuit through a cable 128 that allows full reading of the pressures within the tubing system. The pressure transducer allows monitoring of pressure of fluid in the perfusion circuit, including pulsatile flow, in some examples.

Continuing to refer to FIG. 1, in some embodiments the disclosed devices include an oxygenator 118. In some embodiments, the oxygenator is a tubular body filled with fibers. Oxygen is passed through the tubular body via a fluidly connected oxygen conduit 130 (for example, from an oxygen tank). The oxygenator 118 includes an inlet 132, which is fluidly connected to the pump by a fluid line (such as a third conduit 122 in the perfusion circuit). The oxygenator 118 also includes an outlet 134 fluidly connected to the first conduit 114 and optionally a filter 136 placed between the outlet 134 and the first conduit 114. The outlet 134 is connected to the first conduit of the perfusion circuit 114, which passes to the chamber 102. Perfusion fluid enters the oxygenator 118 from the inlet 132 and is passed through the oxygenator 118 in counterflow to the oxygen from the oxygen conduit 130. The resulting oxygenated perfusion fluid exits the oxygenator 118 through the outlet 134, passes through the filter 136 (if present) and enters the first conduit 114 of the perfusion circuit.

Referring again to FIG. 1, in some embodiments, the disclosed devices also include a temperature regulator or control unit 138 fluidly connected to the perfusion circuit. In some examples, the temperature regulator 138 controls the temperature of the perfusion fluid supplied through the first conduit 114 of the perfusion circuit. In some examples, the temperature regulator 138 includes a heat exchanger for heating or cooling the perfusion fluid to a selected temperature (not shown). In one example, the temperature regulator connects to the system through two external ports located at the oxygenator (not shown). These connections establish a closed circuit of temperature-regulated fluid that circulates continuously around the oxygenator (without having any contact with the perfusate itself), for example in counterflow to the direction of fluid flow in the perfusion circuit. This externally controlled circuit flow by the temperature control unit surrounds the oxygenators and provides heating or cooling as needed to achieve and sustain the target temperature to the perfusate during oxygenation. In some examples, the temperature regulator also includes electrical system and software (such as an electronic module) that controls the perfusate temperature.

In some embodiments, both the temperature regulator and the pump are integrated through an electrical circuit that controls both pumping and temperature regulation functions through a single control panel (for example, on the pump unit).

The function of one or more components of the disclosed devices, including, but not limited to the pump (or pump unit), oxygenator, and/or heat exchanger (or temperature control unit) may be controlled via an electronic module. Thus, in some examples, the disclosed devices include one or more electronic modules, such as one or more computers or minicomputers. The electronic module(s) permit a user to set various operating conditions, including fluid flow rate, perfusion pressure, temperature, and/or perfusion fluid oxygenation that are manually or automatically controlled during operation of the device. The electronic module(s) also permit a user to monitor operating parameters and make adjustments during operation, as needed.

### IV. Methods of Perfusion

Disclosed herein are methods of perfusion of an organ or composite tissue (such as ex vivo perfusion of a composite tissue). In some embodiments, the methods are used for ex vivo preservation of organs or VCAs, for example in which a VCA is removed from a donor and preserved during storage and/or transport prior to implantation of all or a portion of the VCA in a recipient. In other embodiments, the methods can also be used for auto-transplantation, for example, in which a VCA is temporarily removed from a subject (for example, due to traumatic injury), followed by reimplantation or reattachment of all or a portion of the VCA to the same subject. The disclosed methods can be used with any organ or VCA which can be machine perfused, including, but not limited to limbs (e.g., arms or legs), extremities (e.g., hands or feet), digits (e.g., fingers or toes), craniomaxillofacial tissues, or any portion thereof.

In some embodiments, the methods include machine perfusion of one or more organs or VCAs with the machine perfusion devices disclosed herein. In some examples, an organ or VCA is placed in the device chamber on the support platform. In particular examples, the platform and the organ or VCA are in a substantially horizontal position. A substantially horizontal position of the VCA provides a relatively anatomical position and allows alignment of the perfusion cannula with the vessels of the organ or VCA (such as one or more arteries) without kinking. In addition, in some examples, a substantially horizontal position facilitates free drainage of the perfusion fluid from the organ or VCA without an active venous cannula. This can result in low venous pressure in the organ or VCA. As described in the Examples below, VCAs perfused using a disclosed device with the VCA in a substantially horizontal position did not undergo edema during perfusion and did not show signs of venous stasis on subsequent histological analysis following 14 hours of perfusion.

The organ or VCA is attached to the perfusion circuit via the first conduit using a cannula. In some examples, the cannula is inserted in an artery of a VCA. As illustrated in FIG. 2 and discussed above, the cannula can be aligned with the organ vasculature, for example, entering the artery in a substantially horizontal orientation. Perfusion solution is circulated in the perfusion circuit, passing through the pump to the oxygenator (for example, through a third conduit), where the perfusion fluid is oxygenated. After passing through the oxygenator, the oxygenated perfusion fluid optionally passes through a filter and then passes through the first conduit. The perfusion fluid then flows through the cannula into a vessel of the organ or VCA (such as an artery). As discussed below, the flow of the perfusion fluid is pulsatile in some examples. The perfusion fluid drains from the organ or VCA by free drainage through the capillaries and lymph system and passes through the perforations or openings (e.g., mesh) of the platform into the lower portion of the perfusion chamber. The drained (oxygen-depleted) perfusion fluid is collected into a second conduit which returns the fluid to the pump. In some examples, the perfusate is removed from the chamber (through the second conduit) using active suction. In other examples, the perfusate is removed from the chamber (through the second conduit) via gravity flow.

The disclosed methods include perfusing the organ or VCA with an oxygenated perfusion solution. In one non-limiting example, the pO₂ of the solution is about 400 mm Hg. Exemplary perfusion solutions are described in International Patent Application Publication No. WO 2014/059316, incorporated herein by reference in its entirety. In particular examples, the perfusion solution (also referred to herein as HBOC) includes 3-4 g/dL cross-linked hemoglobin, 25-30 mM NaCl, 1-2 mM KCl, 17-19 mM KH₂PO₄, 55-65 mM sodium gluconate, 6-8 mM sodium lactate, 3-4 mM magnesium gluconate, 0.6-0.8 mM CaCl₂ dihydrate, 15-16 mM NaOH, 3-4 mM adenine, 6-8 mM dextrose, 2-3 mM glutathione, 6-8 mM HEPES, 3-4 mM ribose, 20-25 mM mannitol, 35-40 g/L hydroxyethyl starch, and 40-60 mg/dL N-acetylcysteine. In one non-limiting example, the perfusion solution includes about 3.25 g/dL cross-linked hemoglobin, 28.25 mM NaCl, 1 mM KCl, 18.75 mM KH₂PO₄, 60 mM sodium gluconate, 6.75 mM sodium lactate, 3.75 mM magnesium gluconate, 0.725 mM CaCl₂ dihydrate, 15.62 mM NaOH, 3.75 mM adenine, 7.5 mM dextrose, 2.25 mM glutathione, 7.5 mM HEPES, 3.75 mM ribose, 22.5 mM mannitol, 37.5 g/L hydroxyethyl starch, and 50 mg/dL N-acetyl-L-cysteine.

Methods of oxygenating a perfusion solution are known to one of ordinary skill in the art. Machine perfusion devices (such as those described herein) can include oxygenators for providing oxygenation of perfusion solutions. In some embodiments, the perfusion solution is oxygenated such that the pO₂ of the solution is about 300-750 mm Hg, such as about 300-700, 325-710, 335-650, 350-600, 375-575, 400-550, or about 510-600 mm Hg.

The perfusion solution is delivered to the organ or VCA via one or more cannulas which are inserted in a vessel of the organ (such as an artery), for example a vessel that ordinarily supplies blood (such as oxygenated blood) to the organ or VCA. For example, a leg may be perfused through a cannula inserted in the iliac artery, femoral artery, tibial artery, or fibular artery, while an arm may be perfused through a cannula inserted in the axillary artery, brachial artery, radial artery, or ulnar artery. In other examples, a hand may be perfused through a cannula inserted in the radial artery (or branches thereof), the ulnar artery (or branches thereof), the palmar digital artery, or the palmar metacarpal arteries, while a foot may be perfused through either the anterior or posterior tibial artery. A maxillofacial VCA may be perfused through branches of either the internal or external carotid arteries. One of ordinary skill in the art can select an appropriate vessel for perfusion of a particular VCA.

In some embodiments, the flow of the perfusion solution to the organ or VCA is a pulsatile flow (such as having flow rate variations that mimic arterial pulsatile blood flow), for example, pulsatile flow of the perfusion solution through a cannula inserted in an artery of the VCA. In some examples, the pulsatile flow of the perfusion solution is with a pulse of about 50-70 beats per minute (such as about 50, 51, 52, 53, 54, 55, 56, 57, 58, 59, 60, 61, 62, 63, 64, 65, 66, 67, 68, 69, or 70 beats per minute); however, one of ordinary skill in the art can select an alternative pulse rate based on the type and condition of organ that is being perfused. In some examples, the perfusion pressure through the artery is about 10-100 mm Hg (such as about 15-50, about 20-60, about 30-80, about 40-75, about 50-100, about 45-65, about 40-60, or about 50-70 mm Hg). In some examples, the perfusion pressure through the artery is about 50-60 mm Hg. The perfusion pressure will vary according to the size, weight, and vascular resistance of the organ or VCA. One of ordinary skill in the art can select appropriate perfusion pressure for a particular organ or VCA. In some examples, the arterial flow entering a VCA is about 5-100 ml/min (such as about 10-30, about 5-25, about 15-35, about 25-75, about 50-100, about 15-60, about 30-80, about 40-60 ml/min). In some examples, the arterial flow is about 10 ml/min or about 25 ml/min. The flow rate will vary according to the size, weight, and vascular resistance of the VCA. One of ordinary skill in the art can select appropriate flow rates for a particular VCA.

In some examples, the pressure and/or flow rates can be adjusted over the time course of the perfusion of the organ or VCA. For example, the perfusion pressure may be higher and the flow rate lower during the initial perfusion (for example, up to about 4 hours of perfusion time) and then the pressure can subsequently be reduced, for example, as flow rate through the organ or VCA increases. In some examples, maintenance and/or adjustment of flow rates and/or perfusion pressures are made using a software package associated with the device. One of ordinary skill in the art can select appropriate pressures and flows for perfusion of a particular organ or VCA.

In some examples, the perfusate exits the organ or VCA from one or more veins, capillaries, and/or lymph vessels. For example, the methods can include passive drainage into the lower portion of the perfusion chamber.

In some embodiments, the methods include machine perfusion of one or more organ or VCAs with an oxygenated perfusion solution. The perfusion solution is an oxygen carrying solution, such as an HBOC solution. In some non-limiting examples, the perfusion solution is the HBOC perfusion solutions described in International Pat. Publ. No. WO 2014/059316; incorporated herein by reference. In some embodiments the temperature of the solution perfused into the organ is between about 12-37° C. (such as about 12-30° C., 20-37° C., 18-27° C., 20-25° C., 12-28° C., 12-25° C., 12-21° C., 15-25° C., 15-22° C., 15-21° C., 15-20° C., or 20-22° C.). In some embodiments, a sub-normothermic temperature (such as about 20-32° C.) is selected for the perfusion solution. Sub-normothermic temperatures may provide particular advantages over hypothermic or normothermic temperatures. For example, mitochondrial function is maintained at temperatures above about 12° C., allowing maintenance of cellular ATP stores. In addition, decreasing temperatures below about 37° C. reduces the risk of infection by slowing or inhibiting bacterial growth. In some examples, the temperature of the solution perfused into the VCA is about 12, 13, 14, 15, 16, 17, 18, 19, 20, 21, 22, 23, 24, 25, 26, 27, 28, 29, 30, 31, 32, 33, 34, 35, 36, or 37° C. In one non-limiting example, the temperature of the perfusion solution is about 21° C. when it is perfused into the organ or VCA. In additional embodiments, the temperature of the organ or VCA and/or the chamber holding the perfused organ or VCA is also maintained at the same temperature as the perfusate, for example by means of one or more temperature regulators connected to the chamber.

In some examples, the organ or VCA is not perfused with a solution less than about 12° C., for example, the organ or VCA is not perfused with a solution having a temperature of about 11, 10, 9, 8, 7, 6, 5, 4° C. or less. The organ or VCA may be flushed with cold (for example 4-10° C.) solutions, such as lactated Ringer's solution, UW solution, or other solutions prior to machine perfusion or prior to transplantation to a recipient in some examples. In other examples, the organ or VCA is not stored in a solution without perfusion (before and/or after machine perfusion) for more than about 1 hour.

In some examples, the organ or VCA is perfused with an HBOC solution with oxygenation for a period of time to allow for storage and/or transport of the organ (for example from a donor site to a recipient site) prior to allogeneic transplantation and/or for surgical or clinical treatment of the organ or VCA (for example, resection or repair of damaged tissue), for example prior to retransplantation or allogeneic transplantation. In other examples, the organ or VCA is perfused with an HBOC solution with oxygenation for a period of time to allow for storage, transport, and/or collection of one or more tissues (such as skin, adipose, muscle, tendons, and/or bone) from the organ or VCA prior to transplantation of the tissue as an autograft or allograft in a subject (referred to in some instances as “spare part” surgery). In some embodiments, the organ or VCA is perfused for about 1 hour to about 14 days, such as about 1-72 hours, 2-48 hours, 4-24 hours, 8-16 hours, 12-24 hours, 1-14 days, 1-10 days, 1-7 days, 2-14 days, 2-10 days, or 5-10 days. In particular examples, the VCA is perfused for about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36 or more hours or about 1, 2, 3, 4, 5, 6, 7, 8, 9, 10, 11, 12, 13, 14 or more days.

### EXAMPLES

The following examples are illustrative of disclosed embodiments. In light of this disclosure, those of skill in the art will recognize that variations of these examples and other examples of the disclosed technology would be possible without undue experimentation.

### Example 1

### Machine Perfusion and Preservation of Composite Tissue Allotransplant

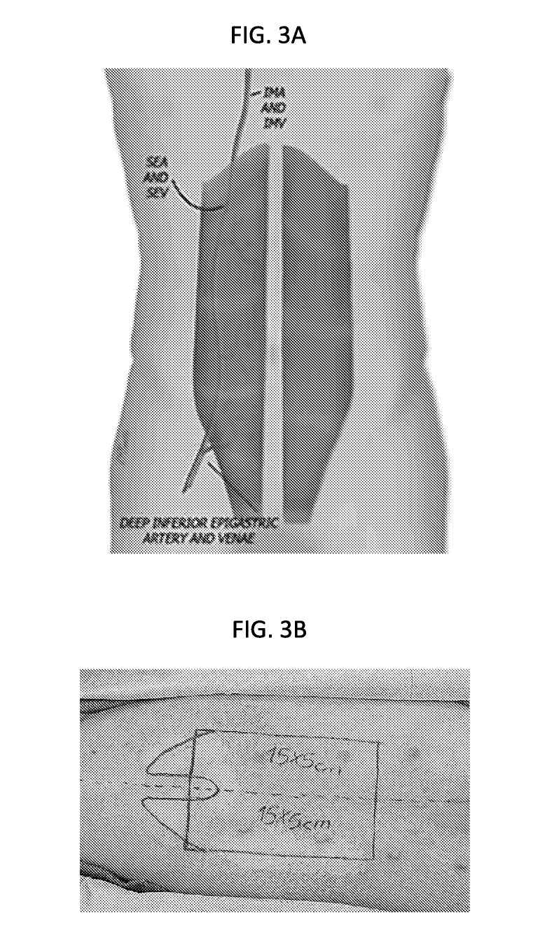

The VCA model was based on a swine vertical rectus myocutaneous (VRAM) flap with two dominant vascular pedicles. The VRAM graft has medium-caliber vessels (artery and vein) feeding a sizable portion of tissue containing skin, subcutaneous adipose tissue and muscle. The recovery and transplantation of the VRAM grafts were based on perfusion by the superior epigastric artery (SEA) vascular pedicle (FIGS. 3A and 3B).

Ex-vivo experiments with the VRAM grafts were conducted over a 14 hour preservation period. VRAM grafts recovered and preserved by machine perfusion in the system described below with a HBOC solution (n=4) were compared to cold storage preservation (CSP) (n=4) as the current standard of care.

Machine perfusion of the skin flaps was performed using a modified Organ Assist Liver Assist® device (Organ Assist, Groningen, The Netherlands) in combination with a hemoglobin-based oxygen carrier solution (International Pat. Publ. No. WO 2014/059316; Fontes et al., Am. J. Transplantation 15:381-394, 2015; both of which are incorporated herein by reference in their entirety). The starting hemoglobin as measured by an ABL800flex (Radiometer, Copenhagen) blood gas analyzer was 3.4 g/dL. The baseline settings for the MP system were: 60 mm Hg pressure, 21° C., FiO₂ 60%, sweep gas 0.3 L/min. Perfusion was initiated with an inlet pressure of 60 mmHg at 1 Hz pulse pressure, achieving a flow of ˜10 mL/min. Initial blood gas values were ˜93% saturated HBOC solution at a pO₂ of ˜400 mmHg. As the initial vasoconstriction from VRAM recovery subsided, the flows increased. The MP device altered centrifugal pump speed to maintain a set pressure. After 2 hours, with flows exceeding 25 ml/min, the pressure set point was lowered to 50 mm Hg where it was maintained throughout the remainder of the perfusion. After 14 hours, the VRAM graft was removed from the MP device, weighed and processed for additional studies.

The device configuration was modified, since the initial Liver Assist® perfusion device prototype was originally developed for liver preservation. A horizontal platform was designed and manufactured in house. A plasticized polyvinyl chloride (PVC) medical mesh was crafted to fit to the upper part of the original organ perfusion chamber (FIGS. 4A and 4B). The PVC medical mesh has shown great biocompatibility, safety and lack of toxicity, chemical stability, flexibility, durability, dependability, is inert to immune reactivity, and is easy to sterilize. There has been extensive approval of materials based on PVC for containers of human blood and blood components and for containers of aqueous solutions for intravenous infusions.

The ex vivo experiments allowed development of a single infusion system with pulsatile flows for the VRAM graft. Since the graft volume and biological characteristics were rather different from livers, the original dual perfusion system was reduced to a single pulsatile (arterial) perfusion system. New software was developed to safely control this set of pressures and flows utilized for the MP of the VRAM graft. In addition, the original disposable system (2 ports) for the livers was split in 2 separate segments as a way to infuse only pulsatile pressures through the arterial infusion port. Furthermore, specialized entrance tubes (cannulas) were utilized due to the smaller size of the VRAM vessels.

The flat surface provided by the PVC mesh in the organ perfusion system allowed free fluid drainage from the VRAM graft during perfusion. The perfusate/preservation solution could drain freely from all the lymphatics and microvascular venous branches within the periphery of the graft. The main vein also drained freely through the mesh. Placing the graft in a substantially straight (horizontal) position with the vascular pedicle horizontally aligned (FIG. 4B) made is possible to sustain low venous pressure by free drainage within standard gravity forces. This position has been shown herein as effective and beneficial for long term perfusion (14 hours) regarding both tissue integrity and overall fluid regulation between the intra and extra vascular spaces. The grafts perfused by MP with this new system lost weight after 14 hours of machine perfusion and showed no signs of venous stasis on subsequent histological analysis.

The PVC mesh also allowed a stable basis for the graft regarding additional manipulations during the MP protocol. Punch biopsies were carried out effectively and without disruption of the macro- and microvascular flow during the MP protocol. The horizontal position of the graft on top of the PVC mesh during the MP protocol also allowed constant monitoring of all the tissues (e.g., skin, adipose and muscle) during the MP protocol. Furthermore, this position allowed constant monitoring of free capillary leakage through the periphery of the graft and the venous system, which is a reliable clinical assessment of the graft perfusion over an extended period of time. The graft placement in a horizontal and anatomic position over the PVC mesh also facilitated the clinical assessment of the arterial flow, regarding the amplitude and frequency of the pulse provide by the pulsatile flow.

In contrast to kidney and liver machine perfusion preservation, where the organs are submerged in the solution, the VRAM graft was kept out of contact with the solution. This prevents the graft skin from developing edema during the 14 hours of machine perfusion. The special design of the organ chamber, with the solution separated from the graft, but closed by a lid, allowed additional moisturizing and humidification of the graft while preventing dehydration.

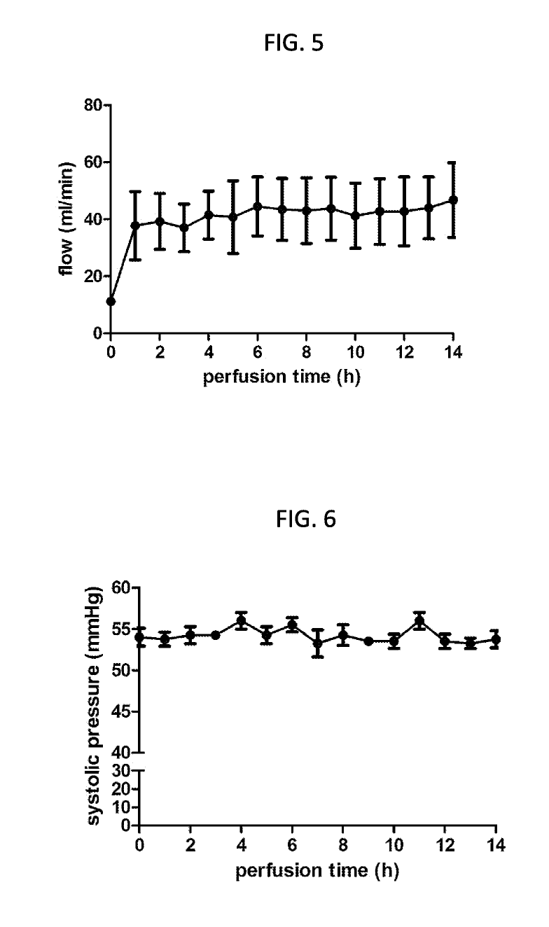

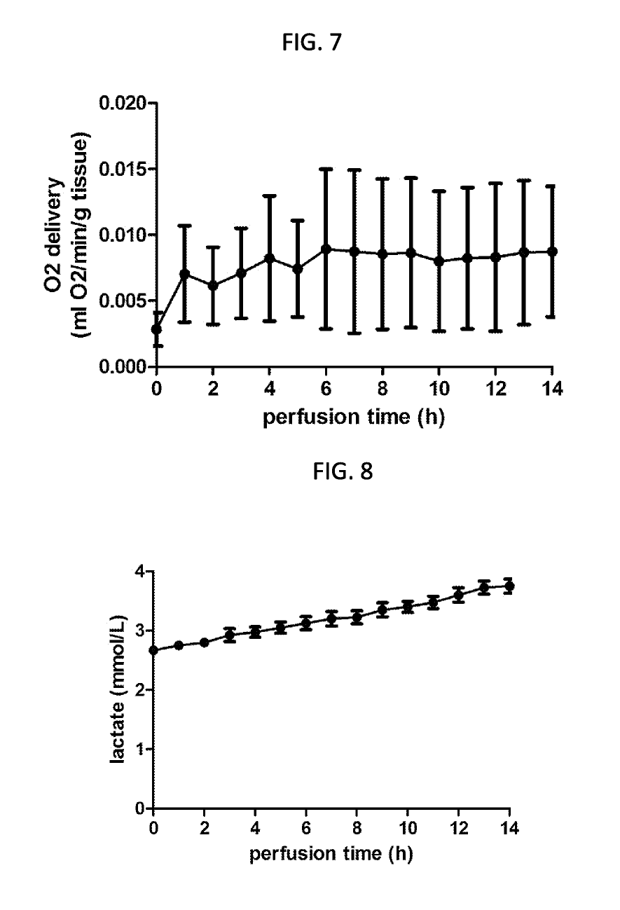

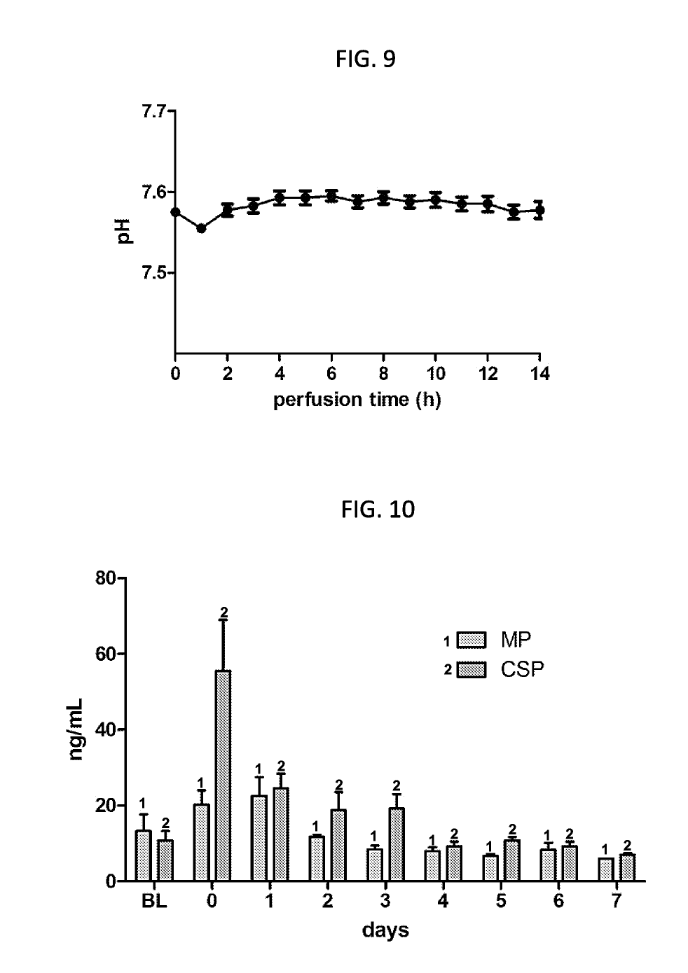

Initial data from the machine perfusion system during the ex vivo experiments showed excellent flow and oxygenation of the VRAM grafts over a 14 hour period. The VRAM grafts were properly perfused with low flows and showed no signs of weight gain or endothelial cell damage during the extended time (14 hours) of machine perfusion (FIG. 5). The MP device was able to provide reliable pressures over the 14 hour perfusion protocol. The system was developed to provide lower than physiological arterial pressures as a way to sustain endothelial cell integrity within the macro- and microvasculature (FIG. 6). The machine perfusion system, in combination with the HBOC solution was capable of delivering adequate amounts of oxygen to the VRAM grafts over 14 hours at 21° C. (FIG. 7). Indirect measures of O₂ delivery were also assessed by measuring lactate concentration in the perfusate (FIG. 8). pH of the perfusate was measured during the course of perfusion (FIG. 9). No NaHCO₃⁻ infusions were necessary to sustain a physiologic pH.

### Example 2

### In Vivo VRAM Graft Transplantation

The in vivo studies included two groups of four animals each. The study group (MP) had four animals transplanted heterotopically with VRAM allografts after a period of 14 hours of preservation with the new MP system. The control group (CSP) had four animals transplanted with VRAM allografts after 14 hours of preservation with CSP as the current standard of care.

Both groups were followed for seven days. The VRAM grafts were biopsied on days 2, 4 and 7. An end-study necropsy was performed on day 7. All the animals received full immunosuppressive therapy of Tacrolimus, Mycophenalate Mofetil and Prednisone. All the animals had daily clinical and laboratory assessments. Additional studies (e.g., transcriptomics, proteomics and metabolomics) were performed to assess graft viability and the impact of ischemia reperfusion injuries (IRI) suffered after this prolonged period of preservation.

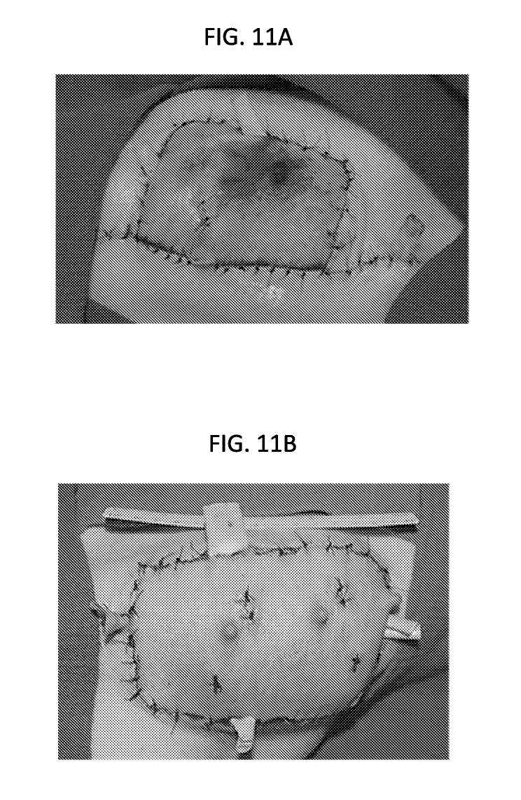

In order to assess the IRI and the level of VRAM damage after 14 hours of preservation on both groups, myoglobin levels were measured daily over a seven day period (FIG. 10). In the control (CSP) group, tissue was necrotic and there were areas of ischemic ulcerations and inflammation within the superficial surface of the graft (FIG. 11A). In contrast, in the MP group, the nipples were well perfused and there were no signs of necrosis or additional inflammation within the superficial surface of the graft (FIG. 11B).

Initial histological assessment of buffered formaldehyde-fixed paraffin-embedded biopsies of skin, muscle, nerve, adipose and muscular tissue was performed by a transplant pathologist. The VRAM allografts were biopsied at days 2, 4 and 7. The skin portion was mildly affected on both groups initially regarding IRI. The CSP group progressed towards further necrosis and ischemic ulcerations of the skin.

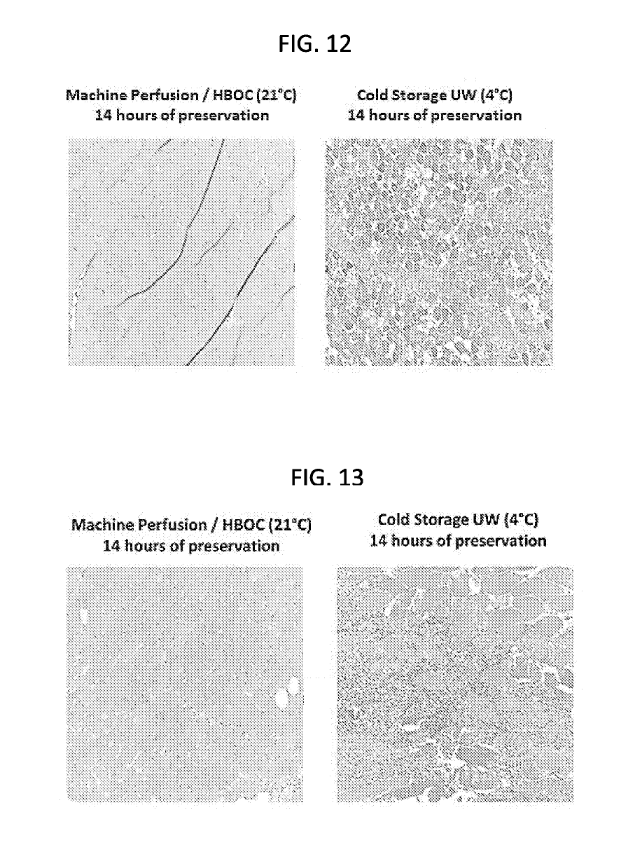

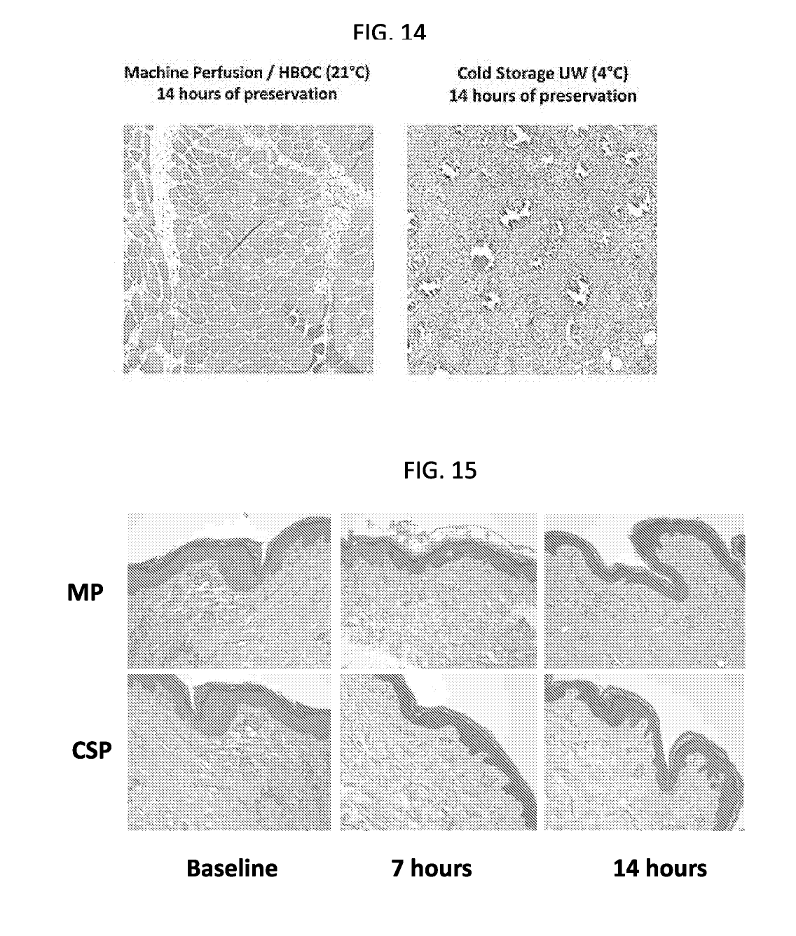

There were significant differences between the two groups (CSP and MP) when overall viability and full thickness tissue integrity was assessed for IRI. The MP group had mild signs of IRI in the three segments of the graft (skin, adipose tissue and muscle). The CSP group had moderate to severe signs of IRI within the three segments of the VRAM grafts. There were signs of considerable and progressive damage within the vascular endothelial cells leading to further apoptosis and necrosis within the adipose and muscular tissues (FIGS. 12-14). Fragmentation of the both the lamina elastica and interna and further involvement of the vasa vasorum was observed. This was further characterized by perivascular edema, red blood cell extravasation, leukocyte adhesion and infiltration, intraluminal thrombi of microvasculature, and progressive loss of the endothelial cell layer in mid-size vessels in the CSP group. The endothelial cell dysfunction led to further vascular leakage. Additional eosinophilic infiltration was detected in the CSP group. Nuclear changes (e.g., pyknosis, karyorrhexis and karyolysis) were further detected as signs of apoptosis and necrosis within the muscular layer. Furthermore, fiber disruption, loss of striation and additional decomposition of both the endomysium and epimysium were clearly noticed in the CSP group. Tissue integrity was also assessed periodically during perfusion. The MP system was able to maintain tissue integrity over a 14 hour period of perfusion under low pressures and with the HBOC at 21° C. (FIG. 15).

### Example 3

### Additional Clinical and Histopathologic Analysis of VRAM Allografts

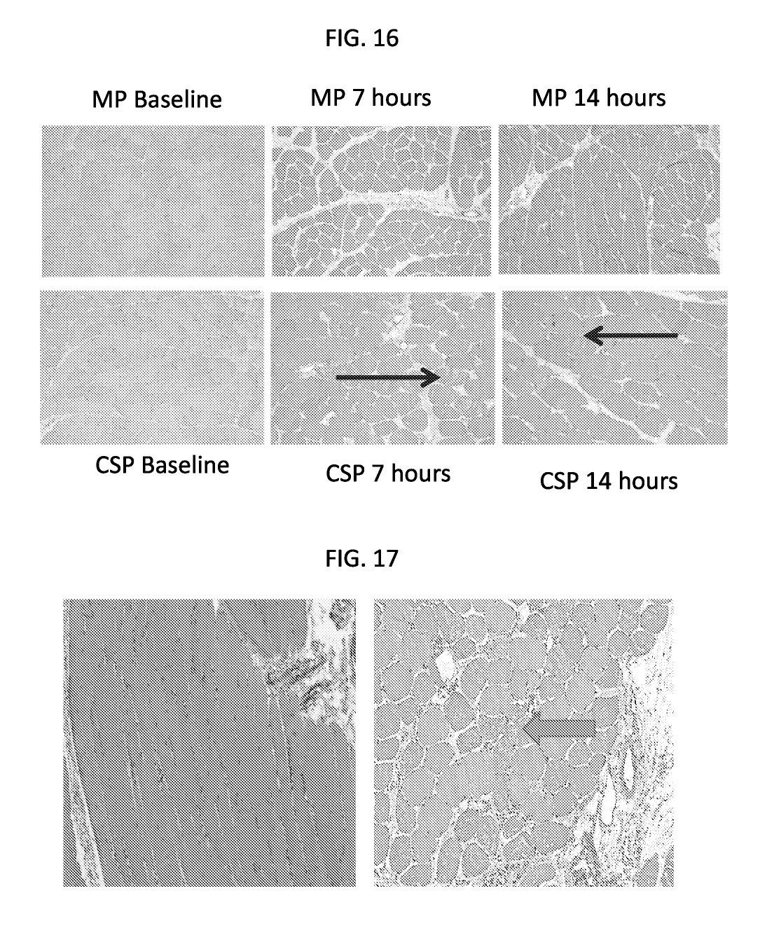

Initial histological assessment of buffered formaldehyde-fixed paraffin-embedded biopsies of skin, muscle, nerve, adipose and muscular tissue from the VRAM allografts described above was performed by a transplant pathologist (H&E staining). The VRAM allografts were biopsied every 4 hours during preservation and at days 2, 4 and 7 after transplantation. Early damage on the CSP grafts was clearly detected within the initial samples (4 and 8 hours). The presence of early hypercontracted sarcomeres (contraction bands, CB) and frequent sarcolemmal ruptures that gave rise to the term “contraction band necrosis” were observed in the sarcomeres, which were subsequently followed by moderate to severe IRI in the CSP flaps in vivo (FIGS. 16 and 17). CBs are thick, irregular, transverse eosinophilic bands in necrotic myocytes. The bands are small groups of hypercontracted and disorganized sarcomeres with thickened Z lines. The sarcolemma is disrupted and the mitochondria located between the CBs swell. CBs occur whenever there is a massive influx of Ca⁺⁺ into the myocytes. The CB became more prominent after reperfusion and led into extensive necrosis within the CSP group. Adiponecrosis and skin necrosis were also significantly higher in the CSP group.

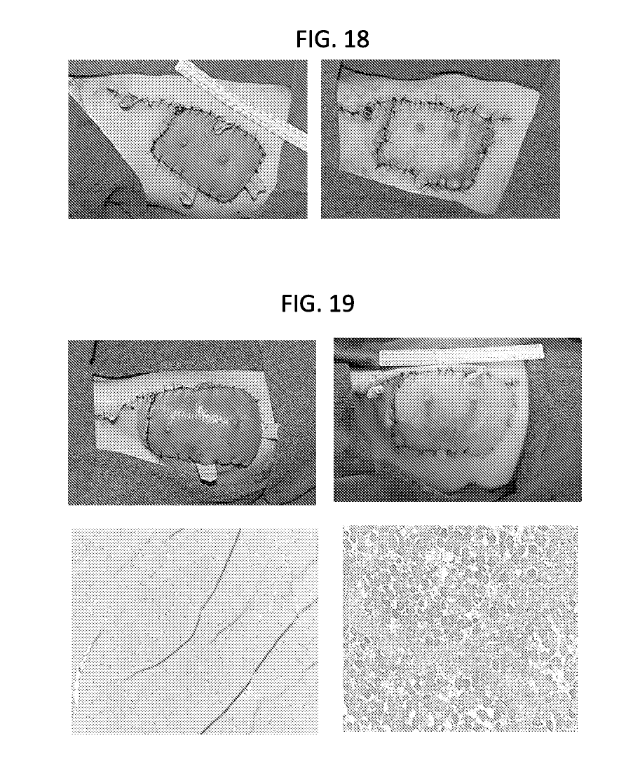

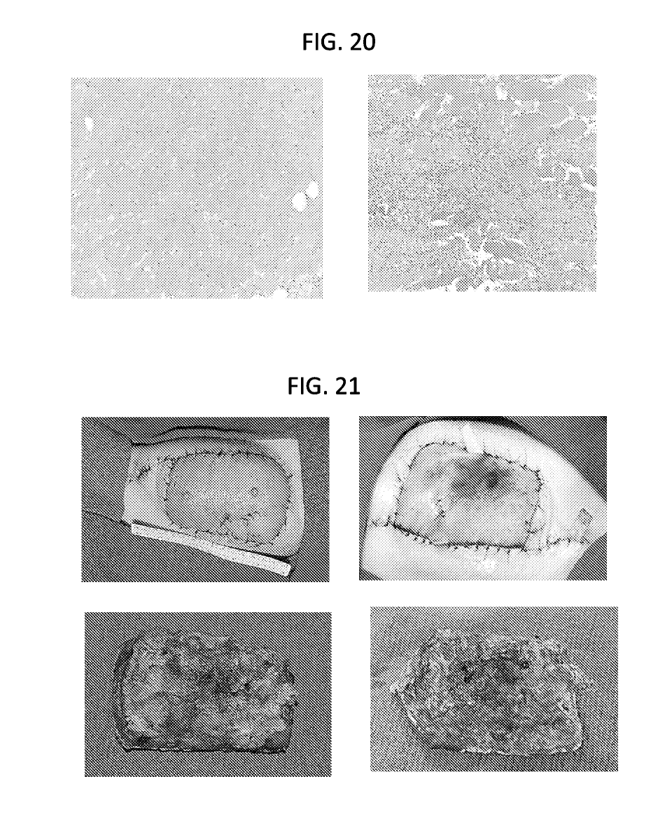

The VRAM grafts reperfused well and had no signs of early technical problems. FIG. 18 shows the clinical aspects of the tissues after transplantation. Pen-Rose drains were utilized to avoid fluid collection within the subcutaneous tissue that could compress the vasculature. The skin portion was mildly affected on both groups initially, indicating some initial ischemia reperfusion injuries (IRI) as a result of the transplant process. The control CSP group progressed towards further necrosis and ischemic ulcerations of the skin, whereas the study MP group stabilized. There were significant differences between the two groups (CSP and MP) when overall viability and full thickness tissue integrity were assessed for IRI. The MP group had mild signs of IRI in the three segments of the graft (e.g., skin, adipose tissue and muscle). The CSP group had moderate to severe signs of IRI within the three segments of the VRAM grafts. There were also signs of considerable irreversible damage within the vascular endothelial cells leading to further apoptosis and necrosis within the adipose and muscular tissues in the CSP group. The presence of perivascular edema, red blood cell extravasation, leukocyte adhesion and infiltration, intraluminal thrombi of microvasculature and progressive loss of the endothelial cell layer in mid-size vessels were also observed in the CSP group. The initial endothelial cell dysfunction apparently led to further vascular leakage in the CSP group. Additional macrophage and eosinophilic infiltration were detected in the CSP group. Nuclear changes (e.g., pyknosis, karyorrhexis and karyolysis) were further observed as signs of apoptosis and necrosis within the muscular layer in the CSP group. Furthermore, fiber disruption, loss of striation and additional decomposition of both the endomysium and epimysium were clearly noticed in the CSP group. These classic histological inflammatory features of significant IRI injuries were rarely noticed in the MP group, showing the beneficial role of effective oxygenation as a way to avoid ischemic injuries during VRAM graft preservation (FIGS. 19-21).

The MP/HBOC graft showed full vessel patency and no signs of necrosis within the deep portions of the graft (FIG. 21). The degree of necrosis and overall tissue damage was significantly higher in the CSP group. There were extensive necrotic areas with moderate to severe amount of inflammation. Progressive neutrophilic infiltration led to necrosis and loss of muscle fibers. Extensive macrophage infiltration was observed leading into granulomatous-like changes resembling pseudo-abscesses surrounded by epithelioid macrophages, or multinucleated giant cells in the CSP, where extensive muscle fiber degeneration and mineralization within multinucleated giant cells are present. The MP/HBOC group had muscle tissue with normal histological features. There were clear signs of superficial necrosis with extensive ulceration in the CSP graft. The MP/HBOC graft had normal features. There were clear signs of extensive tissue necrosis within the subcutaneous in the CSP group. The MP/HBOC graft showed full vessel patency and no signs of necrosis within the deep portions of the graft.

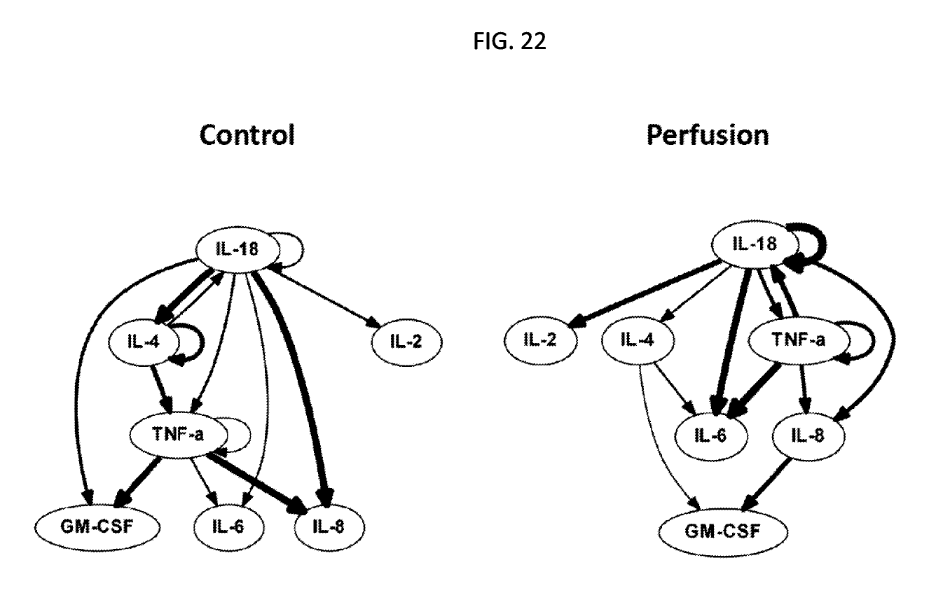

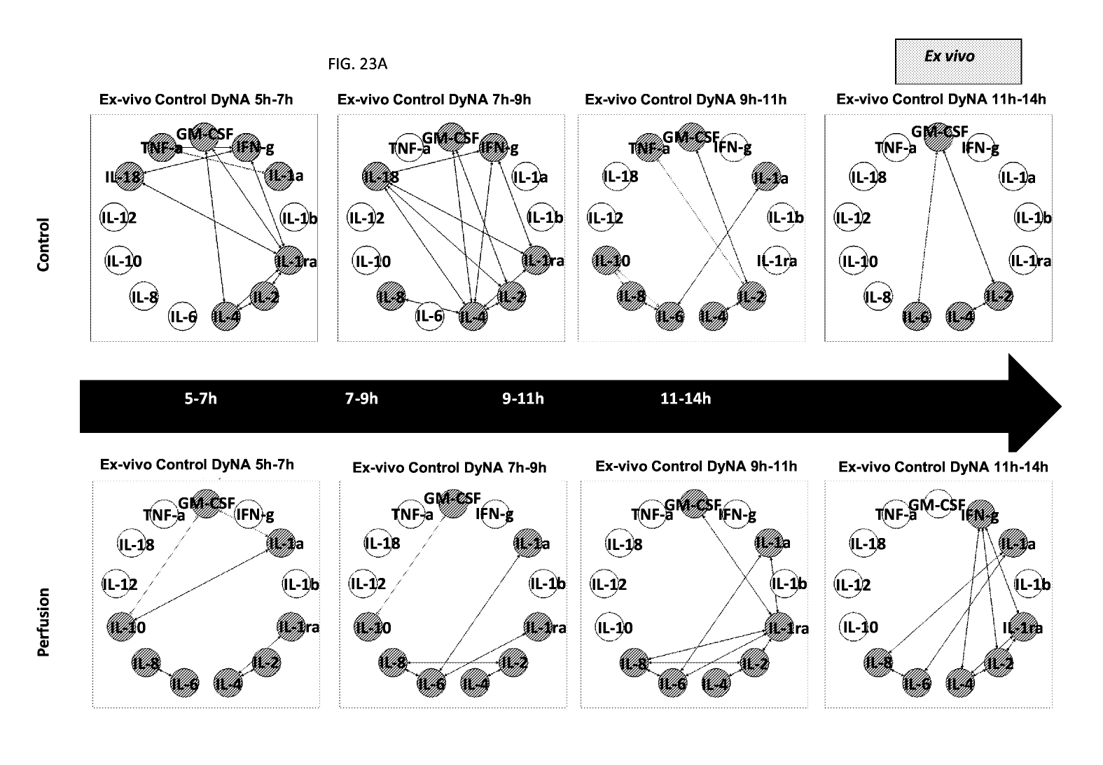

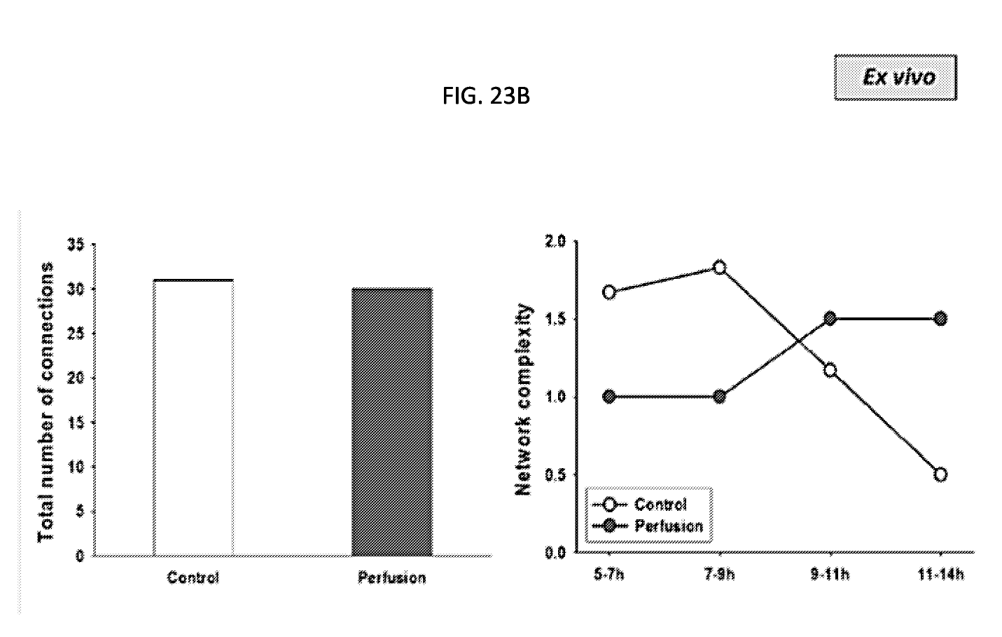

In order to quantify the inflammatory process triggered by IRI and the imminent alloreaction experienced by the VRAM after graft implantation, a full cytokine profile was obtained during VRAM graft preservation in both groups (MP and CSP). Subsequent samples were obtained from tissue biopsies during the post-operative period. Tissue and perfusate assays of interferon IFN-γ, IL-10, IL-12/IL-23 p40, IL-1β, IL-4, IL-6, IL-8 and tumor necrosis factor (TNF)-α were carried out using a Luminex™ beadset from Affymetrix (Santa Clara, Calif.). GM-CSF, IL-1α, IL-1RA, IL-2 and IL-18 were measured using a Luminex™ beadset from Millipore (Merck KGaA, Darmsdadt, Germany). Tissue samples were normalized by protein content in order to account for experimental variability in cell number and protein concentration among individual samples. Standard statistical analysis (ANOVA) of the cytokines' concentration across time points did not show any significant difference between the two groups during the ex-vivo stage. A subsequent integrated system analysis utilizing primary component analysis (PCA), dynamic Bayesian networks (DBN) inference and dynamic network analysis (DyNA) was able to demonstrate the different inflammatory pathways experienced by the two groups regarding the preservation method over a 14 hour period. There was a central role for TNF-α in the CSP group as major promoter for sustained and enhanced inflammation (FIG. 22) as demonstrated by the initial DBN inference. Subsequent dynamic network analysis (DyNA) showed a lower degree of complexity in the CSP inflammatory network in spite sustaining a similar amount of connections (FIGS. 23A and 23B).

Conclusions: MP significantly mitigated IRI, which was manifested earlier within the first 4 hours in the CSP group. Effective ex vivo oxygenation with HBOC decreased post-transplant inflammation in skeletal muscle fibers and upregulated regenerative metabolic pathways driving early recovery from IRI. There was a similar up-regulation of TNF-α in the CSP group, which was similar to previous data obtained in liver allografts after a period of 9 hours of preservation. Effective ex vivo oxygenation with the MP/HBOC system avoided the early (hours) formation of hypercontracted sarcomeres (CB) and the subsequent development (days) of myofiber necrosis, myopathic changes, edema and hemorrhage seen extensively in CSP as the current standard of care. The significant IRI observed in the CSP group yielded a significant hypereosinophilic sarcomere degeneration leading into irreversible loss of muscle fibers, followed by progressive granulomatous inflammation accompanied by the infiltration of large, activated macrophages, epithelioid macrophages and multinucleated giant cells, leading into terminal mineralization and complete loss of muscle mass.

### Example 4

### Metabolomics Analysis

Tissue samples from the VRAM grafts were obtained during preservation (0, 5, 9 and 14 hours) and after the transplant procedure on POD 0, 2, 4 and 7. These tissues were immediately frozen (OCT) and further submitted to Metabolon Inc., Raleigh, N.C. for metabolomics analysis. Following receipt, samples were inventoried, and immediately stored at −80° C. At the time of analysis samples were extracted and prepared for analysis using Metabolon's standard solvent extraction method. The extracted samples were split into equal parts for analysis on the GC/MS and LC/MS platforms. Instrument variability was determined by calculating the median relative standard deviation (RSD) for the internal standards that were added to each sample prior to injection into the mass spectrometers. The sample preparation process was carried out using the automated MicroLab STAR® system from Hamilton Company. Recovery standards were added prior to the first step in the extraction process for QC purposes. Sample preparation was conducted using a proprietary series of organic and aqueous extractions to remove the protein fraction while allowing maximum recovery of small molecules. The resulting extract was divided into two fractions; one for analysis by LC/MS and one for analysis by GC/MS. Samples were placed briefly on a TurboVap® (Zymark) to remove the organic solvent. Each sample was then frozen and dried under vacuum. Samples were then prepared for the appropriate instrument, either LC/MS or GC/MS. The LC/MS portion of the platform was based on a Waters ACQUITY UPLC and a Thermo-Finnigan LTQ mass spectrometer, which consisted of an electrospray ionization (ESI) source and linear ion-trap (LIT) mass analyzer. The sample extract was split into two aliquots, dried, then reconstituted in acidic or basic LC-compatible solvents, each of which contained 11 or more injection standards at fixed concentrations. One aliquot was analyzed using acidic positive ion optimized conditions and the other using basic negative ion optimized conditions in two independent injections using separate dedicated columns. Extracts reconstituted in acidic conditions were gradient eluted using water and methanol both containing 0.1% Formic acid, while the basic extracts, which also used water/methanol, contained 6.5 mM Ammonium Bicarbonate. The MS analysis alternated between MS and data-dependent MS² scans using dynamic exclusion. Overall process variability was determined by calculating the median RSD for all endogenous metabolites (i.e., non-instrument standards) present in 100% of the Client Matrix samples, which are technical replicates of pooled client samples. There were 653 compounds analyzed. Following log transformation and imputation of missing values, if any, with the minimum observed value for each compound, Welch's two-sample t-tests were used to identify biochemicals that differed significantly between experimental groups. An estimate of the false discovery rate (q-value) was calculated to take into account the multiple comparisons that normally occur in metabolomic-based studies. The q-value describes the false discovery rate; a low q-value (q<0.10) is an indication of high confidence in a result. While a higher q-value indicates diminished confidence, it does not necessarily rule out the significance of a result.

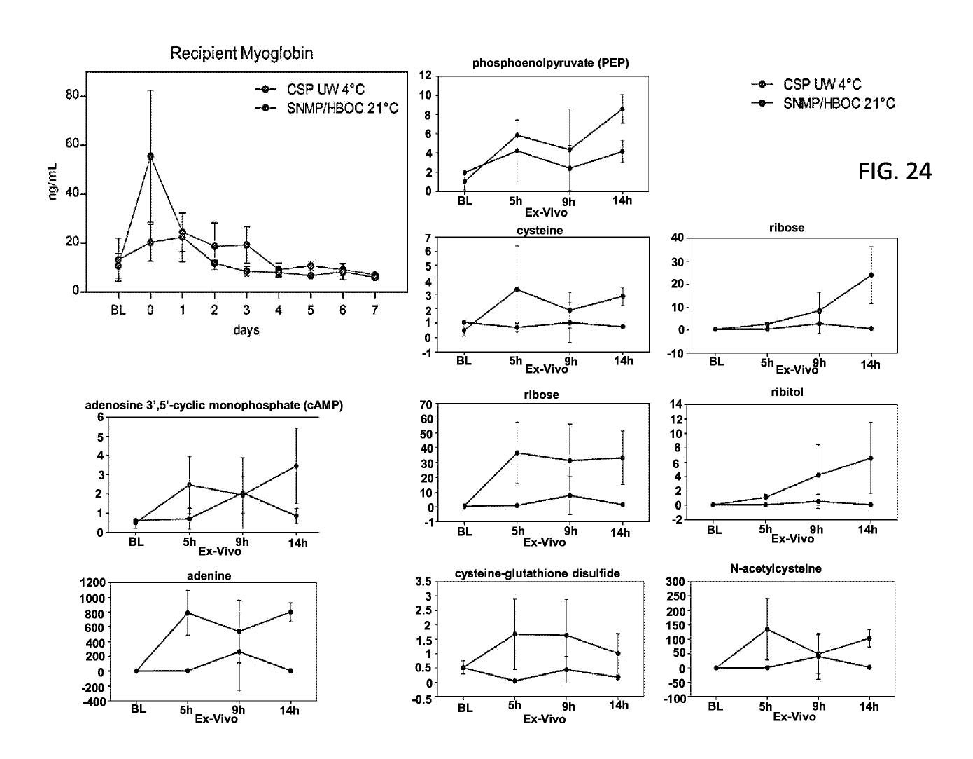

The VRAM grafts in the MP system sustained an intact energetic metabolism fueled by glucose over the 14 hour period of preservation when compared to the CSP group (FIG. 24). MP sustained normal skeletal muscle glycolysis as evident by higher: glucose 6-phosphate (23-fold increase, p=0.01), fructose-6-phosphate (12-fold increase, p=0.03), and phosphoenolpyruvate (8-fold increase, p=0.03). Nucleic acid synthesis was significantly higher in the MP flaps: cysteine (3.88-fold increase, p=0.02), ribose (22-fold increase, p<0.001), ribonate (37-fold increase, p<0.001), and ribitol (10.5-fold increase, p<0.001). MP led to significantly higher levels of reactive oxygen species (ROS) scavengers in the VCAs: glutathione-cysteine disulfide (5.6-fold increase, p=0.01) and N-acetylcysteine (40-fold increase, p=0.007). Furthermore SNMP provided sufficient energy precursors and metabolites: adenine (129-fold increase, p=0.002), cAMP (3.7-fold increase, p=0.02), AMP (3.2-fold increase, p=0.01) and 3′-AMP (2.3-fold increase, p=0.01).

CSP grafts faced extensive amino acid metabolism dysregulation as suggested by significantly higher levels of: N⁶-succinyladenosine (p<0.01), valine (p<0.01), 2-methylbutyrylcarnitine (p=0.01), 3-hydroxyisobutyrate (p=0.01), and ethylmalonate (p=0.009) tissue levels. Glycogen reserves were higher in the MP group. There was adequate glucose supply in the MP and no signs of glycogen breakdown. The pentose metabolites were significantly higher in the MP group, showing a higher anabolic state when compared to the CSP group. The CSP group appeared to have a sustained catabolic state when compared to the MP group. There were signs of higher production of nucleotides and nucleic acids precursors in the MP. There was a significant (30 fold higher) increase in the metabolic pathways related to cell regeneration once oxygenation was effectively provided ex-vivo during preservation. There were signs of higher production of aromatic amino acids in the MP group when compared to the CSP group.

The MP/HBOC system provided more effective anti-oxidant pathways when compared to the CSP group. There were higher levels of end-products from oxidized stress in the MP group, which can be seen as an indirect sign of lower stress from less significant IRIs when compared to the CSP group. Contrary to previous experience with livers, the VRAM grafts under the MP/HBOC system showed lower fatty acid β-oxidation when compared to the CSP group. This means a lower of fatty acids into the mitochondria as a source of fuel. This also favors the initial findings regarding the preferential pathway for glucose as the primary source of energy in striated muscles. Further analysis of the purine metabolism (adenine components) showed indirect signs of higher ATP production in the MP group when compared to the CSP. The adenine family has a variety of roles in cellular respiration and protein synthesis. There were higher levels of cAMP in the MP group, showing higher ATP production in this group. AMP is used as a monomer in RNA synthesis. The cAMP as a derivative of ATP has a significant role in signal transduction. SNMP increased fatty acids (FAs) Ω-oxidation pathway as evident by significantly higher tissue levels of dicarboxylic FAs: 2-hydroxyglutarate (4.8-fold increase, p=0.02), adipate (5.55-fold increase, p=0.003), and 2-hydroxyadipate (2.5-fold increase, p=0.01). Reduction of β-oxidation was evident by substantial increase in the levels of acyl-carnitine metabolites in the SNMP/HBOC grafts: cis-4-decenoyl carnitine (8-fold increase, p=0.04), laurylcarnitine (8.3-fold increase, p=0.02), oleoylcarnitine (9.5-fold increase, p=0.01), myristoleoylcarnitine (22-fold increase, p=0.006), and adipoylcarnitine (7-fold increase, p<0.001). This was mirrored by significantly higher levels of end-products of β-oxidation pathway in the CSP group as shown by 4-hydroxybutyrate (p<0.01). Cellular membrane integrity was well preserved histologically and further evidenced by significantly higher levels of phospholipids in the SNMP/HBOC group: oleoylcholine (5-fold increase, p<0.01) and choline (3-fold increase, p=0.01). In addition, early signs of myopathy were observed with significantly higher tissue levels of butyryl-carnitine (p=0.04) in the CSP grafts, which were further corroborated by histopathologic analysis.

Conclusions: Metabolic precursors of nucleotide synthesis were significantly upregulated in the MP/HBOC group. These precursors appear to be implicated in a strong regenerative response elicited by effective oxygenation of skeletal muscle, which also has a positive impact in energy utilization and ROS scavengers. The MP/HBOC protocol also promoted effective ex vivo oxygenation and shifted skeletal muscle metabolic profile from β-oxidation towards Ω-oxidation during VCA preservation when compared to the prolonged anoxia under hypothermic conditions induced by CSP. This can be interpreted as a sign of mitochondrial dysfunction experienced by the CSP group. In fact, Ω-oxidation is linked to balanced redox state and less oxidative damage during stressful conditions induced by these experiments. In contrast, CSP appeared to increase a reactive skeletal muscle β-oxidation pathway, which leads into oxidative damage and disintegration of cellular membranes when prolonged hypothermia, anoxia, and limited glucose supply is imposed. Contrary to the CSP group, MP/HBOC protected skeletal muscle against early graft myopathy. These complex metabolic features seen in the both the muscle and adipose tissue were extensively corroborated by the serial histological findings, revealing in a close analogy the same protective role exerted by effective ex-vivo oxygenation documented extensively in previous liver experiments.

In view of the many possible embodiments to which the principles of the disclosure may be applied, it should be recognized that the illustrated embodiments are only examples and should not be taken as limiting the scope of the invention. Rather, the scope of the invention is defined by the following claims. We therefore claim as our invention all that comes within the scope and spirit of these claims.

1. An organ perfusion device, comprising,
a perfusion chamber comprising an organ support platform for supporting an organ to be transplanted, wherein the organ support platform comprises one or more perforations;
a perfusion circuit fluidly coupled to the perfusion chamber, comprising a first conduit for providing an oxygenated perfusion fluid to the organ, and a second conduit for carrying oxygen depleted perfusion fluid away from the organ;
an oxygenating device fluidly coupled to the perfusion circuit to oxygenate the perfusion fluid;
a pulsatile pump fluidly coupled to the perfusion circuit for circulating the perfusion fluid through the first conduit of the perfusion circuit into the perfusion chamber and to the organ support platform where the perfusion fluid can flow through a vascular perfusion cannula;
a reservoir along the perfusion circuit for containing a portion of the perfusion fluid from the perfusion circuit, wherein the reservoir communicates with an outlet to the second conduit; and
a temperature regulator for controlling the temperature of the perfusion fluid supplied through the first conduit.

2. The organ perfusion device of claim 1, wherein liquid is not introduced into the chamber other than through the vascular perfusion cannula.

3. The organ perfusion device of claim 1, wherein the organ support platform is a substantially flat surface for supporting an elongated organ.

4. The organ perfusion device of claim 1, wherein the perfusion circuit circulates the perfusion fluid through the first conduit into the vascular perfusion cannula, through the organ, then through the one or more perforations in the organ support platform, then into the reservoir and through the outlet to the second conduit.

5. The organ perfusion device of claim 1, wherein the reservoir is a lower portion of the perfusion chamber.

6. (canceled)

7. The organ perfusion device of claim 1, wherein the organ support platform is medical grade mesh or medical grade PVC mesh.

8. (canceled)

9. The organ perfusion device of claim 1, further comprising a removable lid fitting over the top of the chamber.

10. The organ perfusion device of claim 1, further comprising one or more electronic modules connected to the pump, the oxygenating device, or the temperature regulation circuit.

11. (canceled)

12. The organ perfusion device of claim 1, further comprising a filter between the oxygenating device and the first conduit and/or a pressure transducer connected to the pump, the first conduit, or the second conduit.

13. (canceled)

14. The organ perfusion device of claim 1, wherein the temperature regulator comprises a closed circuit conduit where a temperature regulation fluid can circulate through the oxygenating device to regulate the temperature of the perfusion fluid in the perfusion circuit.

15. A device assembly comprising:
the device of claim 1; and
an organ situated in the chamber on the organ support platform, wherein the vascular perfusion cannula is inserted in an artery of the organ.

16. The device assembly of claim 15, wherein the organ is a vascularized composite allotransplant.

17. The device assembly of claim 16, wherein the vascularized composite allotransplant comprises one or more of a limb, extremity, digit, craniomaxillofacial tissue, or a portion thereof.

18. A method for machine perfusion of an organ, comprising perfusing the organ with a hemoglobin-based oxygen carrier solution, wherein the solution is oxygenated, and wherein the solution is at a temperature of about 12-37° C., and wherein the external surface of the organ is not submerged in the perfusion fluid.

19. The method of claim 18, wherein the organ is placed in a substantially horizontal position during perfusion.

20. The method of claim 18, wherein the solution is delivered to the organ in a pulsatile flow via one or more arteries of the organ and/or wherein the solution passively drains from the organ.

21. (canceled)

22. The method of claim 18, wherein the solution is at a temperature between about 12-25° C.

23. (canceled)

24. The method of claim 18, wherein the method comprises perfusing the organ prior to allotransplantation, or perfusing the organ during repair or recovery prior to autologous transplantation or reattachment.

25. The method of claim 18, wherein the organ is a vascularized composite allotransplant.

26. The method of claim 25, wherein the vascularized composite allotransplant comprises one or more of a limb, extremity, digit, craniomaxillofacial tissue, or a portion thereof.

27. The method of claim 25, wherein the vascularized composite allotransplant is perfused during collection of one or more tissues from the vascularized composite allotransplant for allotransplantation or autologous transplantation.

28. A method for machine perfusion of an organ, comprising:
placing the organ on the organ support platform of the device of claim 1;
inserting the vascular perfusion cannula in an artery of the organ; and
perfusing the organ with an oxygenated hemoglobin-based oxygen carrier perfusion solution circulating through the perfusion circuit.

29. The method of claim 28, wherein the perfusion solution drains from the organ by passive flow or gravity and passes through the one or more perforations in the organ support platform by gravity flow.

30. The method of claim 28, wherein the oxygenated perfusion solution is delivered to the organ in a pulsatile flow via the vascular perfusion cannula.

31. The method of claim 28, wherein the perfusion solution is at a temperature between about 12-25° C.

32. (canceled)

33. The method of claim 28, wherein the organ is a vascularized composite allotransplant.

34. The method of claim 33, wherein the vascularized composite allotransplant comprises one or more of a limb, extremity, digit, craniomaxillofacial tissue, or a portion thereof.
